(19) United States
(12) Patent Application Publication
(10) Pub. No.: US 2006/0172736 A1
(43) Pub. Date: Aug. 3, 2006

(54) Methods and apparatus for operating a wireless electronic device having a plurality of communication platforms

(75) Inventor: Ron Nevo, Portland, OR (US)

Correspondence Address: INTEL CORPORATION, P.O. BOX 5326, SANTA CLARA, CA, 95056-5326, US

(73) Assignee: INTEL CORPORATION

(21) Appl. No.: 11/048,952

(22) Filed: Feb. 1, 2005

(51) Int. Cl. H04Q 7/20

(52) U.S. Cl. 455/435.1

(57) ABSTRACT

Embodiments of methods and apparatus for operating a wireless electronic device having a plurality of communication platforms are generally described herein. Other embodiments may be described and claimed.

### TECHNICAL FIELD

The present disclosure relates generally to wireless communication systems, and more particularly, to methods and apparatus for operating a wireless electronic device having a plurality of communication platforms.

### BRIEF DESCRIPTION OF THE DRAWINGS

FIG. 1 is a schematic diagram representation of an example wireless communication system according to an embodiment of the methods and apparatus disclosed herein.

FIG. 2 is a block diagram representation of the example wireless communication system of FIG. 1.

FIG. 3 is a block diagram representation of an example wireless electronic device of FIG. 2.

FIG. 4 is a flow diagram representation of one manner in which the example wireless electronic device of FIG. 2 may be configured to operate.

FIG. 5 is a flow diagram representation of another manner in which the example wireless electronic device of FIG. 2 may be configured to operate.

FIG. 6 is a flow diagram representation of yet another manner in which the example wireless electronic device of FIG. 2 may be configured to operate.

FIG. 7 is a block diagram representation of an example processor system that may be used to implement the example wireless electronic device of FIG. 2.

### DETAILED DESCRIPTION

In general, methods and apparatus for operating a wireless electronic device having a plurality of communication platforms are described herein. The methods and apparatus described herein are not limited in this regard.

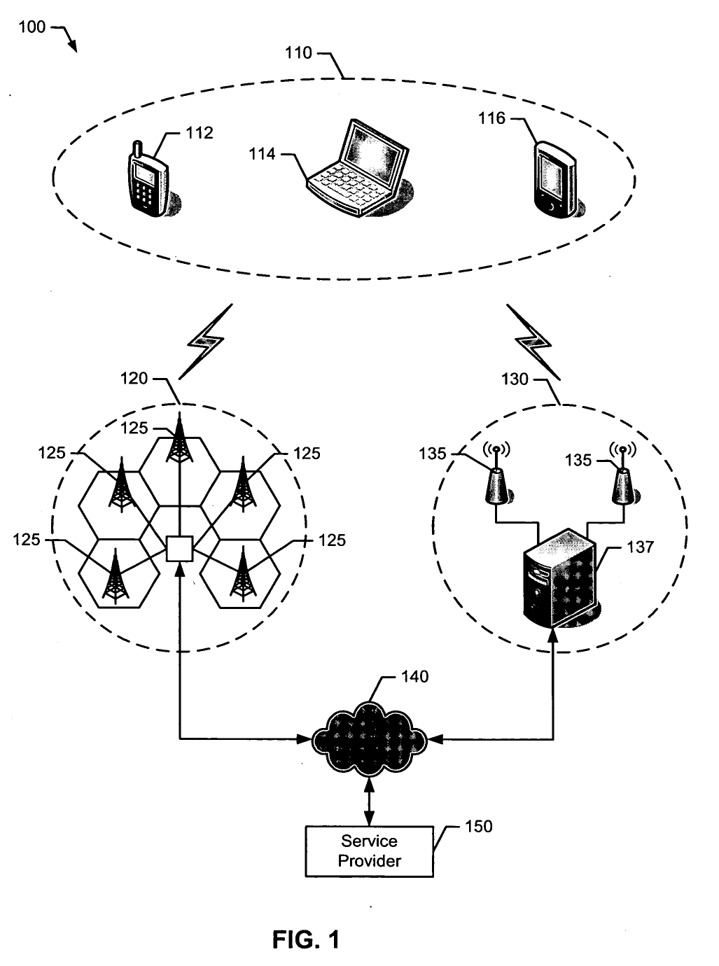

Referring to FIG. 1, an example wireless communication system 100 is described herein. In particular, the wireless communication system 100 may include one or more wireless electronic devices 110, generally shown as 112, 114, and 116. For example, the wireless electronic devices 110 may be a laptop computer, a handheld computer, a tablet computer, a cellular telephone (e.g., a smart phone), a pager, an audio and/or video player (e.g., an MP3 player or a DVD player), a game device, a digital camera, a navigation device (e.g., a GPS device), and/or other suitable wireless electronic devices. Although FIG. 1 depicts three wireless electronic devices, the wireless communication system 100 may include more or less wireless electronic devices.

Each of the wireless electronic devices 110 may use a variety of modulation techniques such as time-division multiplexing (TDM) modulation, frequency-division multiplexing (FDM) modulation, orthogonal frequency-division multiplexing (OFDM) modulation, multi-carrier modulation (MDM), and/or other suitable modulation techniques to communicate via wireless communication links. For example, the laptop computer 114 may implement OFDM modulation to transmit large amounts of digital data by splitting a radio frequency signal into multiple small sub-signals, which in turn, are transmitted simultaneously at different frequencies. In particular, the wireless electronic devices 110 may use OFDM modulation as described in the 802.xx family of standards developed by the Institute of Electrical and Electronic Engineers (IEEE) and/or variations and evolutions of these standards (e.g., 802.11x, 802.15, 802.16x, etc.). In one example, the wireless electronic devices 110 may operate in accordance with the 802.16 family of standards developed by IEEE to provide for fixed, portable, and/or mobile broadband wireless access (BWA) networks (e.g., the IEEE std. 802.16, published 2004).

The wireless electronic devices 110 may also use direct sequence spread spectrum (DSSS) modulation (e.g., the IEEE std. 802.11b) and/or frequency hopping spread spectrum (FHSS) modulation (e.g., the IEEE std. 802.11). Further, the wireless electronic devices 110 may also operate in accordance with other suitable wireless communication protocols that require very low power such as Bluetooth, Ultra Wideband (UWB), and/or radio frequency identification (RFID) to communicate via wireless communication links. Alternatively, the wireless electronic devices 120 may communicate via wired communication links (not shown). For example, the wireless electronic devices 120 may use a serial interface, a parallel interface, a small computer system interface (SCSI), an Ethernet interface, a universal serial bus (USB) interface, a high performance serial bus interface (e.g., IEEE 1394 interface), and/or any other suitable type of wired interface to communicate. The methods and apparatus described herein are not limited in this regard.

The wireless communication system 100 may also include a first communication network 120 and a second communication network 130. Although FIG. 1 depicts two wireless communication networks, the wireless communication system 100 may include additional wired and/or wireless communication networks. In one example, the first communication network 120 may be a wireless wide area network (WWAN) including one or more radio access networks (RAN). Each RAN may include one or more base stations (BS), generally shown as 125, and other radio components necessary to provide communication services to the wireless electronic devices 110. The BS 125 may operate in accordance with the applicable standard(s) for providing wireless communication services to the wireless electronic devices 110. That is, each BS 125 may be configured to operate in accordance with one or more of several wireless communication protocols to communicate with the wireless electronic devices 110. In particular, these wireless communication protocols may be based on analog, digital, and/or dual-mode communication system standards such as Frequency Division Multiple Access (FDMA)-based standards, the Time Division Multiple Access (TDMA)-based standards (e.g., Global System for Mobile Communications (GSM), General Packet Radio Services (GPRS), Enhanced Data GSM Environment (EDGE), Universal Mobile Telecommunications System (UMTS), etc.), Code Division Multiple Access (CDMA)-based standards, Wideband CDMA (WCDMA)-based standards, variations and evolutions of these standards, and/or other suitable wireless communication standards.

The second communication network 130 may be a wireless local area network (WLAN) including one or more access points (AP), generally shown as 135, and a server 137. The AP 135 and the server 137 may be configured to operate in accordance with one or more of several wireless communication protocols to communicate with the wireless electronic devices 110. In one example, these wireless communication protocols may be based on one or more Wireless Fidelity (Wi-Fi) standards defined by the Wi-Fi Alliance (e.g., IEEE std. 802.11a, 802.11b, and/or 802.11g). The AP 135 and the server 137 may also operate in accordance with Bluetooth, UWB, RFID and/or other suitable wireless communication standards. Although the second communication network 130 is depicted in FIG. 1 to include a server (e.g., the server 137), the APs 135 may be standalone components. For example, the APs 135 may be connected directly to the Internet through a router (not shown). The methods and apparatus described herein are not limited in this regard.

In addition, the wireless communication system 100 may include a core network 140 and a service provider 150. The core network 140 (e.g., the Internet) may interconnect the service provider 150 to the first and second communication networks 120 and 130. While the core network 140 and the service provider 150 are depicted as separate blocks in FIG. 1, the functions performed by the core network 140 and/or the service provider 150 may be integrated within a single component.

Further, the wireless communication system 100 may include other WWAN and/or WLAN devices (not shown) such as network interface devices and peripherals (e.g., network interface cards (NICs)), access points (APs), gateways, bridges, hubs, etc. to implement a cellular telephone system, a satellite system, a personal communication system (PCS), a two-way radio system, a one-way pager system, a two-way pager system, a personal computer (PC) system, a personal data assistant (PDA) system, a personal computing accessory (PCA) system, and/or any other suitable communication system. Although certain examples have been described above, the scope of coverage of this disclosure is not limited thereto.

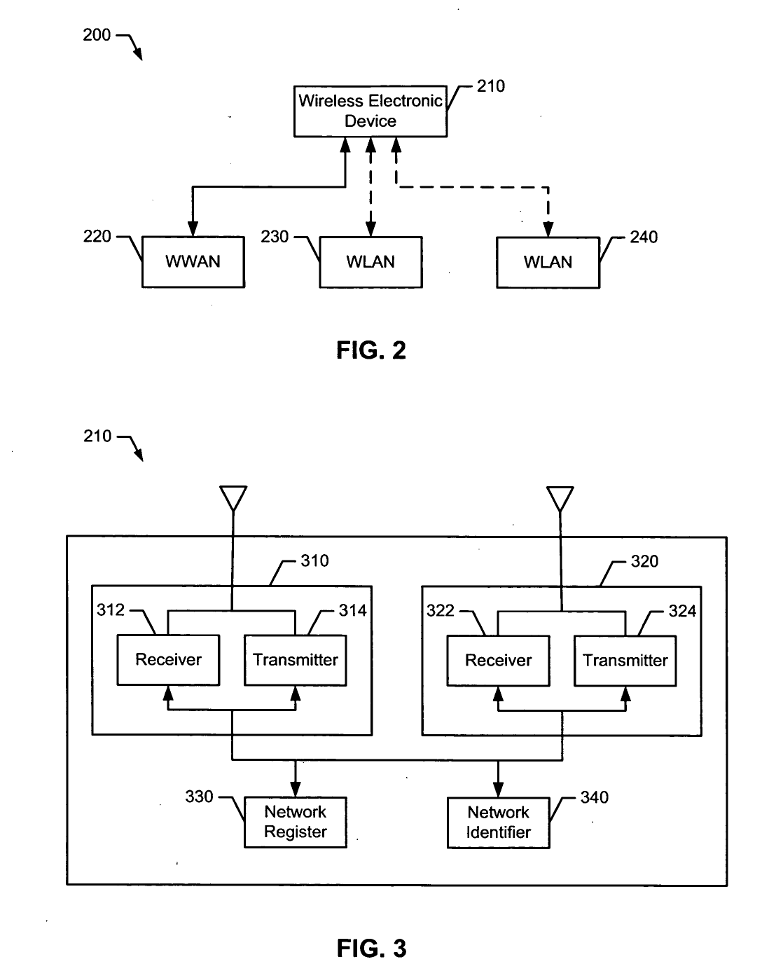

In the example of FIG. 2, a wireless communication system 200 may include a wireless electronic device 210, a first communication network 220, a second communication network 230, and a third communication network 240. The wireless electronic devices 210 may be a laptop computer, a handheld computer, a tablet computer, a cellular telephone (e.g., a smart phone), a pager, an audio and/or video player (e.g., an MP3 player or a DVD player), a game device, a digital camera, a navigation device (e.g., a GPS device), and/or other suitable wireless electronic devices.

In one example, the first communication network 220 may be a wireless wide area network (WWAN), and the second and third communication networks 230 and 240 may be wireless local area networks (WLAN). The WWAN 220 may be a network operating in accordance with, for example, GSM, CDMA, TDMA, and/or other cellular wireless communication protocols. The WLANs 230 and 240 may be networks operating in accordance with, for example, Bluetooth, Wi-Fi, UWB, and/or other short-range wireless communication protocols. Although FIG. 2 depicts three communication networks, the wireless communication system 200 may include more or less wired and/or wireless communication networks.

While the methods and apparatus disclosed herein are described with respect to WLANs and/or WWANs, the methods and apparatus disclosed herein may be applied to other suitable types of wireless communication networks. For example, the methods and apparatus disclosed herein may be applied to BWA networks, wireless personal area networks (WPANs) and/or wireless metropolitan area networks (WMANs).

The wireless electronic device 210 may operate in various modes that require different amount of power. In particular, the wireless electronic device 210 may operate in an active mode, which requires a greater amount of power relative to other operating modes (i.e., high power consumption level). In the active mode, the wireless electronic device 210 may execute an application or a program to generate a visual output on a display screen and/or an audio output via a speaker, to receive a user input via a human interface device, to read and/or write to a memory, and/or to transmit and/or receive communication information for an individual to converse in a phone call, check for voice messages, browse the Internet, etc. For example, a cellular telephone may require full power to operate in the active mode for the individual to place and/or receive a phone call. The wireless electronic device 210 may also operate in an idle or standby mode when the individual is not actively operating the wireless electronic device but the wireless electronic device 210 is readily available to operate in the active mode when necessary. For example, a cellular telephone may operate in the idle mode to monitor for a paging message from one or more base stations via a paging channel. In particular, the paging message is indicative of an incoming communication such as a voice call, a text message, streaming media, etc. Thus, the cellular telephone may require less power to operate in the idle mode than in the active mode (i.e., medium power consumption level).

To further reduce power consumption, the wireless electronic device 210 may operate in the idle mode as described herein. In one example, the wireless electronic device 210 may request for information associated with a communication network (e.g., the WLAN 230 or the WLAN 240) to identify and connect to the communication network. In another example, the wireless electronic device 210 may monitor for information associated with a communication network to identify and connect to the communication network. Further, the wireless electronic device 210 may identify and/or connect to a communication network based on movement associated with the wireless electronic device 210. The methods and apparatus described herein are not limited this regard.

Turning to FIG. 3, for example, the wireless electronic device 210 may include a first communication platform 310 to communicate with a first communication network such as the WWAN 220. The wireless electronic device 210 may also include a second communication platform 320 to communicate with a second communication network such as the WLAN 230. Each of the first and second communication platforms 310 and 320 may include a receiver and a transmitter. The first communication platform 310 may include a receiver 312 and a transmitter 314. Likewise, the second communication platform 320 may include a receiver 322 and a transmitter 324. Although FIG. 3 depicts the first communication platform 310 to communicate with a communication network via a wireless link, the first communication platform 310 may be configured to communicate with a communication network via a wired link.

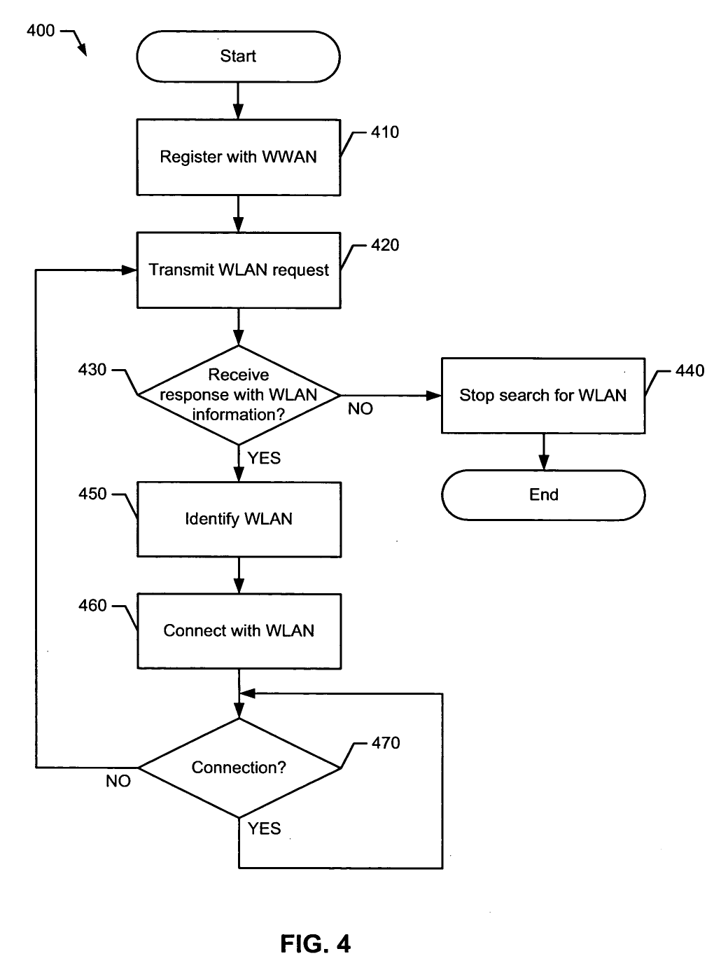

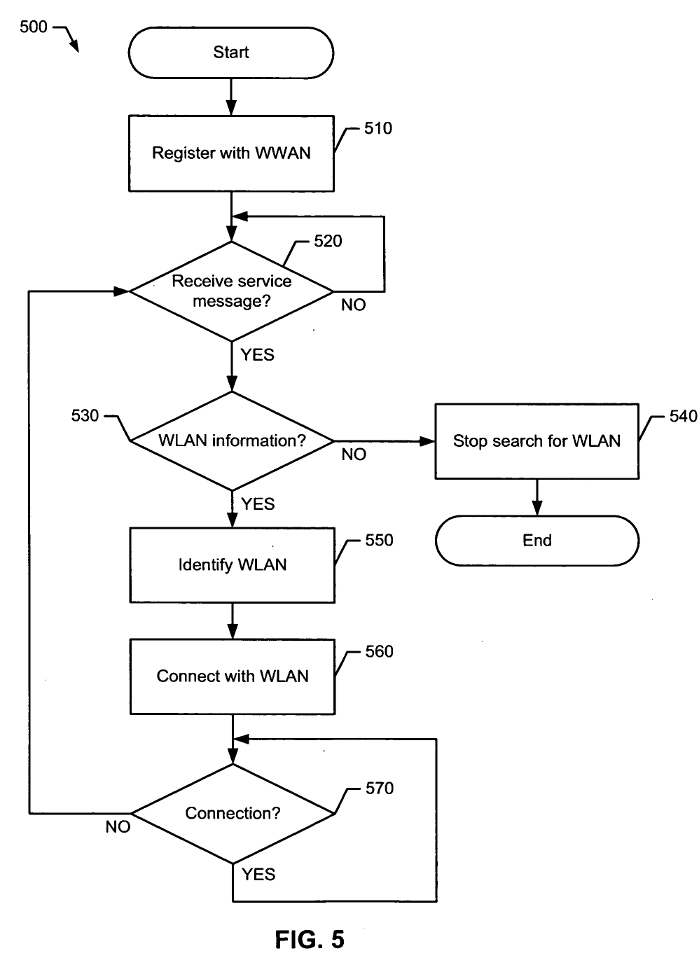

The wireless electronic device 210 may also include a network register 330, a connection identifier 340, and a controller 350. As described in detail and in connection with FIGS. 4, 5, and/or 6, the network register 330 may be configured to register with the WWAN 220 via the first communication platform 310. The connection identifier 340 may be configured to identify a condition indicative of a wireless connection associated with the second communication platform 320 and the WLAN 230 based on information associated with the wireless electronic device 210 and/or the WLAN 230 from the WWAN 220. The controller 350 may be configured to operate the second communication platform 320 based on the condition indicative of the wireless connection associated with the second communication platform 320 and the WLAN 230.

While the components shown in FIG. 3 are depicted as separate blocks within the wireless electronic device 210, the functions performed by some of these blocks may be integrated within a single semiconductor circuit or may be implemented using two or more separate integrated circuits. For example, although the receiver 312 and the transmitter 314 are depicted as separate blocks within the wireless electronic device 210, the receiver 312 may be integrated into the transmitter 314 (e.g., a transceiver). In a similar manner, the receiver 322 may be integrated into the transmitter 324. In another example, the network register 330, the connection identifier 340 and/or the controller 350 may also be integrated into a single component. The methods and apparatus described herein are not limited in this regard.

FIGS. 4, 5, and 6 depict different manners in which the example wireless electronic device 210 of FIG. 2 may be configured to operate. The example processes 400, 500 and 600 of FIGS. 4, 5, and 6, respectively, may be implemented as machine-accessible instructions utilizing any of many different programming codes stored on any combination of machine-accessible media such as a volatile or nonvolatile memory or other mass storage device (e.g., a floppy disk, a CD, and a DVD). For example, the machine-accessible instructions may be embodied in a machine-accessible medium such as a programmable gate array, an application specific integrated circuit (ASIC), an erasable programmable read only memory (EPROM), a read only memory (ROM), a random access memory (RAM), a magnetic media, an optical media, and/or any other suitable type of medium. Further, although a particular order of actions is illustrated in FIGS. 4, 5, and 6, these actions can be performed in other temporal sequences. Again, the example processes 400, 500, and 600 are merely provided and described in conjunction with the apparatus of FIGS. 2 and 3 as examples of different ways to configure a wireless electronic device to operate.

Referring to FIG. 4, for example, the process 400 may begin with the wireless electronic device 210 (e.g., via the network register 330) registering with the WWAN 220 (block 410). In particular, the wireless electronic device 210 and the WWAN 220 may authenticate with each other to establish a wireless connection. The WWAN 220 may update a database (not shown) to indicate that the wireless electronic device 210 has registered with the WWAN 220. For example, the database may indicate the location of the wireless electronic device 210.

To reduce power consumption, the wireless electronic device 210 may use the WWAN 220 to identify a condition indicative of a wireless connection associated with the second communication platform 320 and a WLAN such as the WLAN 230. For example, the wireless electronic device 210 may receive information associated with the second communication platform 320 from the WWAN 220 to determine whether an operable wireless connection (e.g., a connection with a high signal-strength level) exists between the second communication platform 320 and the WLAN 230. If the wireless electronic device 210 fails to identify an operable wireless connection between the second communication platform 320 and the WLAN 230, the wireless electronic device 210 may operate the second communication platform 320 in a sleep mode (e.g., low power consumption level). In particular, the wireless electronic device 210 may disable or shut down components of the second communication platform 320 (e.g., the receiver 322 and/or the transmitter 324) that are not in use to reduce power consumption.

In particular, the wireless electronic device 210 (e.g., via the first communication platform 310) may transmit a wireless connection request to a WLAN server requesting for information associated with the wireless electronic device 210 or the WLAN 230 (block 420). For example, the wireless connection request may be a short messaging service (SMS) message. The SMS message may include information associated with the WLAN 230 such as coverage information, type information, channel information, identification information (e.g., service set identifier (SSID)), authentication information, synchronization information, and/or other suitable information. In particular, the coverage information may indicate signal strength (e.g., signal-to-interference ratio, etc.) of the WLAN to establish a wireless connection with the wireless electronic device 210. The type information may indicate the type of network such as Bluetooth, Wi-Fi, etc. of the WLAN 230. The channel information may indicate the channel for communication used by the WLAN 230. The identification information may be a sequence of characters that uniquely identifies the WLAN 230. The authentication information may be an authentication key for the wireless electronic device 210 to establish wireless connection with the WLAN 230.

The wireless electronic device 210 (e.g., via the network identifier 340) may monitor for a response from the WLAN server (e.g., the server 137 of FIG. 1) via the WWAN 220 (block 430). If the wireless electronic device 210 receives a response without information associated with the WLAN 230, the wireless electronic device 210 may stop searching for the WLAN 230 (block 440). The wireless electronic device 210 (e.g., via the controller 350) may operate the second communication platform 320 in the sleep mode. As noted above, the wireless electronic device 210 may disable or shut down components of the second communication platform 320 (e.g., the receiver 322 and/or the transmitter 324) that are not in use to reduce power consumption.

Otherwise if the wireless electronic device 210 receives a response with information associated with the WLAN 230 at block 430, the wireless electronic device 210 may proceed to scan for the WLAN 230 based on the information associated with the WLAN 230 (block 450). Accordingly, the wireless electronic device 210 may connect with the WLAN 230 (block 460). The wireless electronic device 210 may monitor the condition of the wireless connection with the WLAN 230 to determine whether to maintain the wireless connection (block 470). If the WLAN 230 provides adequate coverage, the wireless electronic device 210 may maintain the wireless connection with the WLAN 230. Otherwise if the WLAN 230 does not provide adequate coverage (e.g., outside the coverage of the WLAN 230), control may return to block 420 to search for another WLAN such as the WLAN 240.

Although the methods and apparatus disclosed herein are described above with respect to SMS messages, the methods and apparatus disclosed herein are readily applicable to many other types of communication services such as enhanced messaging service (EMS), multimedia messaging service (MMS), etc. The methods and apparatus described herein are not limited in this regard.

The wireless electronic device 210 may search for a WLAN in a proactive manner as described above in connection with FIG. 4. In another example, the wireless electronic device 210 may search for a WLAN in a passive manner as described in connection with FIG. 5. Referring to FIG. 5, for example, the process 500 may begin with the wireless electronic device 210 registering with the WWAN 220 (block 510). In particular, the wireless electronic device 210 and the WWAN 220 may authenticate with each other to establish a wireless connection. The WWAN 220 may update a database (not shown) to indicate that the wireless electronic device 210 has registered with the WWAN 220. For example, the database may indicate the location of the wireless electronic device 210.

To reduce power consumption, the wireless electronic device 210 may use the WWAN 220 to identify a condition indicative of a wireless connection associated with the second communication platform 320 and a WLAN such as the WLAN 230. As noted above, for example, the wireless electronic device 210 may receive information associated with the second communication platform 320 from the WWAN 220 to determine whether an operable wireless connection exists between the second communication platform 320 and the WLAN 230 (e.g., a connection with a signal strength level greater than an operating threshold). If the wireless electronic device 210 fails to identify an operable wireless connection between the second communication platform 320 and the WLAN 230, the wireless electronic device 210 may operate the second communication platform 320 in a sleep mode (e.g., the wireless electronic device 210 may disable or shut down components of the second communication platform 320 that are not in use).

In particular, the wireless electronic device 210 (e.g., via the network identifier 340) may monitor for a network service message (block 520). For example, the network service message may be a cellular broadcast message. If the wireless electronic device 210 does not receive a network service message via the first communication platform 310, the wireless electronic device 210 may continue to monitor for a network service message. Otherwise if the wireless electronic device 210 receives a network service message, the wireless electronic device 210 may determine whether the network service message includes information associated with a WLAN such as the WLAN 230 (block 530). For example, the network service message may indicate whether the WLAN 230 may provide WLAN coverage to the wireless electronic device 210. The service message may also include information such as coverage information, type information, channel information, identification information, authentication information, synchronization information, and/or other suitable information.

If the network service message does not include information associated with the WLAN 230 at block 530, the wireless electronic device 210 may stop searching for a WLAN (block 540). Otherwise if the network service message includes information associated with the WLAN 230, the wireless electronic device 210 may scan for the WLAN 230 based on the information (block 550). For example, the identification information may be an SSID that identifies the WLAN 230. Accordingly, the wireless electronic device 210 may connect with the WLAN 230 (block 560). The wireless electronic device 210 may monitor the wireless connection with the WLAN 230 to determine whether to maintain the wireless connection (block 570). If the WLAN 230 provides adequate coverage, the wireless electronic device 210 may maintain the wireless connection with the WLAN 230. Otherwise if the WLAN 230 does not provide adequate coverage (e.g., outside the coverage of the WLAN 230), control may return to block 520 to search for another WLAN such as the WLAN 240. The methods and apparatus described herein are not limited in this regard.

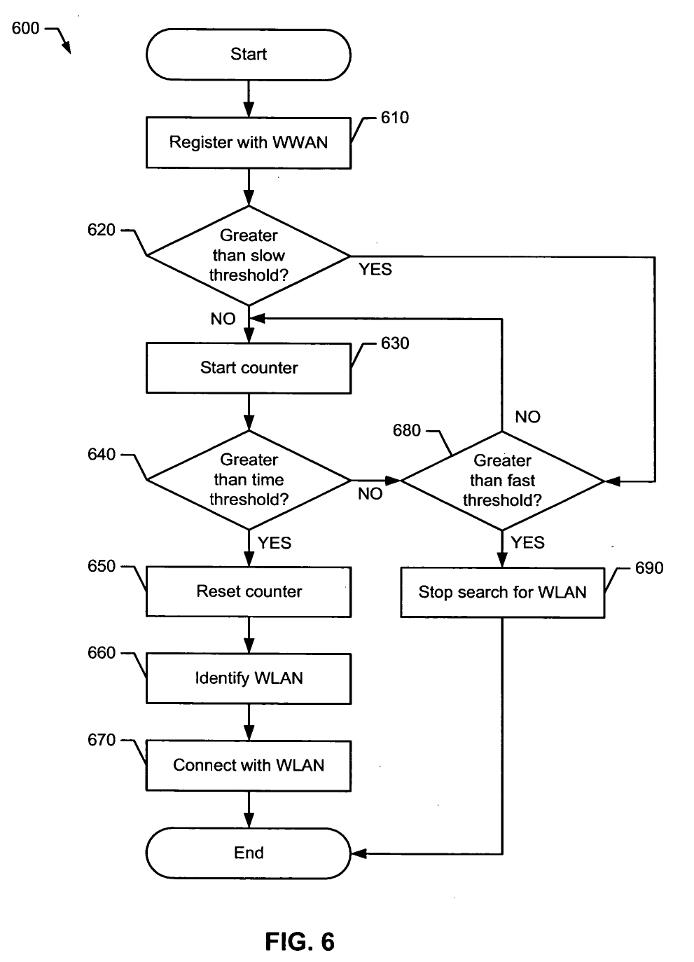

To identify a wireless connection with greater connectivity, the wireless electronic device 210 may search for a wireless connection with a communication network based on movement characteristic of the wireless electronic device 210. In one example, the wireless electronic device 210 traveling in a vehicle may search for and subsequently establish a wireless connection with a WLAN. However, the WLAN 230 may not be able to maintain an operable wireless connection with the wireless electronic device 210 to exchange data when the vehicle carrying the wireless electronic device 210 is moving at a relatively high speed and/or within the coverage area of the WLAN 230 for a relatively short period of time. Thus, the wireless electronic device 210 may reduce power consumption by operating as described in connection with FIG. 6.

Turning to FIG. 6, the process 600 may begin with the wireless electronic device 210 registering with the WWAN 220 (block 610). In particular, the wireless electronic device 210 and the WWAN 220 may authenticate with each other to establish a wireless connection. The WWAN 220 may update a database (not shown) to indicate that the wireless electronic device 210 has registered with the WWAN 220. For example, the updated database may indicate the location of the wireless electronic device 210.

To reduce power consumption, the wireless electronic device 210 may use the WWAN 220 to identify a condition indicative of a wireless connection associated with the second communication platform 320 and a WLAN such as the WLAN 230. As noted above, for example, the wireless electronic device 210 may receive information associated with wireless electronic device 210 from the WWAN 220 to whether an operable wireless connection exists between the second communication platform 320 and the WLAN 230. If the wireless electronic device 210 fails to identify an operable wireless connection between the second communication platform 320 and the WLAN 230, the wireless electronic device 210 may operate the second communication platform 320 in a sleep mode (e.g., the wireless electronic device 210 may disable or shut down components of the second communication platform 320 that are not in use).

In particular, the wireless electronic device 210 may receive information associated with movement characteristic of the wireless electronic device 210. For example, the wireless electronic device 210 may be traveling in a vehicle. Accordingly, the WWAN 220 may provide the speed of the wireless electronic device 210. In one example, the WWAN 220 may determine the speed of the wireless electronic device 210 based on the duration between handoffs from one BS (e.g., BS 125 of FIG. 1) to another, from one cell to another, etc. in a RAN (e.g., RAN 120 of FIG. 1). The WWAN 220 may also determine the speed of the wireless electronic device 210 based on a global position system (GPS), an inertia-based navigation system, and/or other suitable geographical location systems. Further, the WWAN 220 may determine the speed of the wireless electronic device 210 based on location determination algorithms such as round time estimate, angle of arrival, etc. Alternatively, the wireless electronic device 120 may include micro-electro-mechanical (MEM) devices (not shown) such as accelerometers to estimate the speed of the wireless electronic device 120.

Based on geographical location systems, the wireless electronic device 210 (e.g., the network identifier 340) may determine whether the speed of the wireless electronic device 210 is greater than a slow threshold (block 620). In one example, the slow threshold may be five miles per hour (mph). If the speed of the wireless electronic device 210 is less than or equal to the slow threshold, the wireless electronic device 210 may start a counter to keep track of a duration of time in which the wireless electronic device 210 is moving less than or equal to the slow threshold (block 630). To avoid using resources to scan for a WLAN and establish a wireless connection with WLAN for a relatively short period of time, the counter may be used to keep track of a period when the wireless electronic device 210 may be relatively stationary or moving at relatively slow speed. For example, the vehicle carrying the wireless electronic device 210 may be temporarily stopped at a traffic light or a stop sign.

Accordingly, the wireless electronic device 210 may determine whether the counter is greater than a time threshold (block 640). If the counter is less than or equal to the time threshold, the wireless electronic device 210 may reset the counter (block 650). With the wireless electronic device 210 being relatively stationary or moving at relatively slow speed for a period of time, the wireless electronic device 210 may search for, establish, and maintain an operable wireless connection with a WLAN. Accordingly, the wireless electronic device 210 may identify a WLAN such as the WLAN 230 (block 660). The wireless electronic device 210 may connect to the WLAN 230 (block 670). Thus, the wireless electronic device 210 may search for and establish an operable wireless connection with a WLAN to exchange data.

Otherwise if the counter is less than or equal to the time threshold at block 640, the wireless electronic device 210 may determine whether the speed is greater than a fast threshold (block 680). If the speed of the wireless electronic device 210 is less than or equal to the fast threshold, the wireless electronic device 210 may proceed to block 630 to start the counter as described above. Otherwise if the speed of the wireless electronic device 210 is greater than the fast threshold, the wireless electronic device 210 may stop searching for a WLAN (block 690).

Turning back to block 620, if the speed of the wireless electronic device 210 is greater than the slow threshold, the wireless electronic device 210 may determine whether the speed is greater than the fast threshold (block 680). If the speed of the wireless electronic device 210 is less than or equal to the fast threshold, the wireless electronic device 210 may proceed to block 630 to start the counter as described above. Otherwise if the speed of the wireless electronic device 210 is greater than the fast threshold, the wireless electronic device 210 may stop searching for a WLAN instead of consuming power to search and establish an inoperable wireless connection with a WLAN (e.g., a connection with a WLAN that may not maintainable and/or maintainable for a relatively short period of time) (block 690). The methods and apparatus described herein are not limited in this regard.

As mentioned above, while the methods and apparatus disclosed herein are described with respect to WLANs and/or WWANs, the methods and apparatus disclosed herein may be applied to other suitable types of wireless communication networks. For example, the methods and apparatus disclosed herein may be applied to BWA networks, WPANs and/or WMANs.

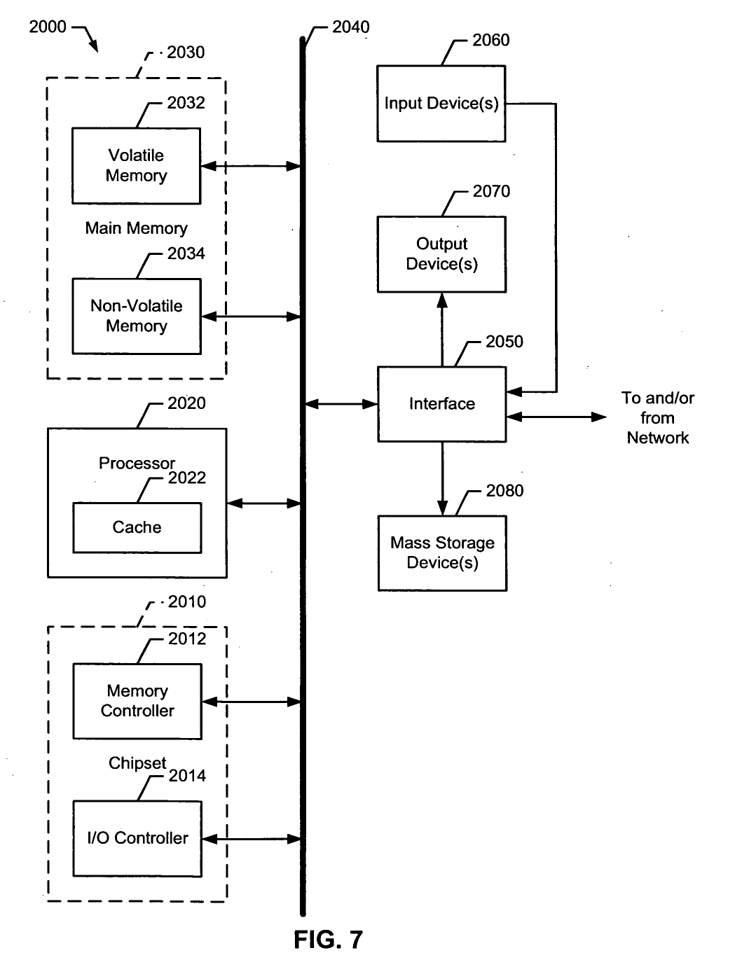

FIG. 7 is a block diagram of an example processor system 2000 adapted to implement the methods and apparatus disclosed herein. The processor system 2000 may be a desktop computer, a laptop computer, a handheld computer, a tablet computer, a PDA, a server, an Internet appliance, and/or any other type of computing device.

The processor system 2000 illustrated in FIG. 7 may include a chipset 2010, which may include a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, WLAN components, WMAN components, WWAN components, and/or other suitable processing components. For example, the processor 2020 may be implemented using one or more of the Intel® Pentium® technology, the Intel® Itanium® technology, the Intel® Centrino™ technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output interface (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 7 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain example methods, apparatus, and articles of manufacture have been described herein, the scope of coverage of this disclosure is not limited thereto. On the contrary, this disclosure covers all methods, apparatus, and articles of manufacture fairly falling within the scope of the appended claims either literally or under the doctrine of equivalents. For example, although the above discloses example systems including, among other components, software or firmware executed on hardware, it should be noted that such systems are merely illustrative and should not be considered as limiting. In particular, it is contemplated that any or all of the disclosed hardware, software, and/or firmware components could be embodied exclusively in hardware, exclusively in software, exclusively in firmware or in some combination of hardware, software, and/or firmware.

What is claimed is:

1. A method comprising:
registering a wireless electronic device having a plurality of communication platforms with a first communication network operating in accordance with a first communication protocol via a first communication platform;
identifying a condition indicative of a wireless connection associated with a second platform of the wireless electronic device and a second communication network operating in accordance with a second communication protocol based on information from the first communication network, the information being associated with one of the wireless electronic device or the second communication network; and
operating the second communication platform based on the condition indicative of the wireless connection.

2. A method as defined in claim 1, wherein identifying the condition indicative of the wireless connection associated with the second communication platform and the second communication network comprises requesting for the information associated with one of the wireless electronic device or the second communication network.

3. A method as defined in claim 1, wherein identifying the condition indicative of the wireless connection associated with the second communication platform and the second communication network comprises transmitting a network request message via the first communication platform to a server associated with the second communication network.

4. A method as defined in claim 1, wherein identifying the condition indicative of the wireless connection associated with the second communication platform and the second communication network comprises monitoring for the information associated with one of the wireless electronic device or the second communication network via the first communication platform.

5. A method as defined in claim 1, wherein identifying the condition indicative of the wireless connection associated with the second communication platform and the second communication network comprises receiving a broadcast message having the information associated with one of the wireless electronic device or the second communication network via the first communication platform.

6. A method as defined in claim 1, wherein identifying the condition indicative of the wireless connection associated with the second communication platform and the second communication network comprises identifying the condition indicative of the wireless connection associated with the second communication platform and the second communication network based on information associated with one or more of coverage, channel, service set identifier, authentication, or synchronization of the second communication network.

7. A method as defined in claim 1, wherein identifying the condition indicative of the wireless connection associated with the second communication platform and the second communication network comprises identifying the condition indicative of the wireless connection associated with the second communication platform and the second communication network based on information associated with movement characteristic of the wireless electronic device.

8. A method as defined in claim 1, wherein operating the second communication platform based on the condition indicative of the wireless connection associated with the second communication platform and the second communication network comprises operating the second communication platform in a sleep mode in response to one of a condition indicative of the wireless connection having a signal strength below a threshold or a condition indicative of a failure to connect the wireless electronic device and the second communication network.

9. A method as defined in claim 1, wherein the first communication network comprises a wireless wide area network, and wherein the second communication network comprises a wireless local area network.

10. An article of manufacture including content, which when accessed, causes a machine to:
register a wireless electronic device having a plurality of communication platforms with a first communication network operating in accordance with a first communication protocol via a first communication platform;
identify a condition indicative of a wireless connection associated with a second communication platform of the wireless electronic device and a second communication network operating in accordance with a second communication protocol based on information from the first communication network, the information being associated with one of the wireless electronic device or the second communication network; and
operate the second communication platform based on the condition indicative of the wireless connection associated with the second communication platform and the second communication network.

11. An article of manufacture as defined in claim 10, wherein the content, when accessed, causes the machine to identify the condition indicative of the wireless connection associated with the second communication platform and the second communication network by requesting for the information associated with one of the wireless electronic device or the second communication network.

12. An article of manufacture as defined in claim 10, wherein the content, when accessed, causes the machine to identify the condition indicative of the wireless connection associated with the second communication platform and the second communication network by transmitting a network request message via the first communication platform to a server associated with the second communication network.

13. An article of manufacture as defined in claim 10, wherein the content, when accessed, causes the machine to identify the condition indicative of the wireless connection associated with the second communication platform and the second communication network by monitoring for the information associated with one of the wireless electronic device or the second communication network via the first communication platform.

14. An article of manufacture as defined in claim 10, wherein the content, when accessed, causes the machine to identify the condition indicative of the wireless connection associated with the second communication platform and the second communication network by receiving a broadcast message having the information associated with one of the wireless electronic device or the second communication network via the first communication platform.

15. An article of manufacture as defined in claim 10, wherein the content, when accessed, causes the machine to identify the condition indicative of the wireless connection associated with the second communication platform and the second communication network by identifying the condition indicative of the wireless connection associated with the second communication platform and the second communication network based on information associated with movement characteristic of the wireless electronic device.

16. An article of manufacture as defined in claim 10, wherein the content, when accessed, causes the machine to operate the second communication platform based on the condition indicative of the wireless connection associated with the second communication platform and the second communication network by operating the second communication platform of the wireless electronic device in a sleep mode in response to one of a condition indicative of the wireless connection having a signal strength below a threshold or a condition indicative of a failure to connect the wireless electronic device and the second communication network.

17. An apparatus comprising:
a first communication platform to communicate with a first communication network operating in accordance with a first communication protocol;
a second communication platform to communicate with a second communication network operating in accordance with a second communication protocol;
a network register coupled to the first and second communication platforms to register a wireless electronic device with the first communication network; and
a connection identifier coupled to the first and second communication platforms to identify a condition indicative of a wireless connection associated with the second communication platform and the second communication network based on information from the first communication network, the information being associated with one of the wireless electronic device or the second communication network; and
a controller coupled to the second communication platform to operate the second communication platform based on the condition indicative of the wireless connection associated with the second communication platform and the second communication network.

18. An apparatus as defined in claim 17, wherein the network identifier is configured to request for the information associated with one of the wireless electronic device or the second communication network via the first communication platform.

19. An apparatus as defined in claim 17, wherein the network identifier is configured to transmit a network request message via the first communication platform to a server associated with the second communication network.

20. An apparatus as defined in claim 17, wherein the network identifier is configured to monitor for the information associated with one of the wireless electronic device or the second communication network via the first communication platform.

21. An apparatus as defined in claim 17, wherein the network identifier is configured to receive a broadcast message having the information associated with one of the wireless electronic device or the second communication network via the first communication platform.

22. An apparatus as defined in claim 17, wherein the network identifier is configured to identify the condition indicative of the wireless connection associated with the second platform and the second communication network based on information associated with movement characteristic of the wireless electronic device.

23. An apparatus as defined in claim 17, wherein the controller is configured to operate the second communication platform in a sleep mode in response to one of a condition indicative of the wireless connection having a signal strength below a threshold or a condition indicative of a failure to connect the wireless electronic device and the second communication network.

24. A system comprising:
a flash memory; and
a processor coupled to the flash memory to register a wireless electronic device having a plurality of communication platforms with a first communication network operating in accordance with a first communication protocol via a first communication platform, to identify a condition indicative of a wireless connection associated with a second communication platform of the wireless electronic device and a second communication network operating in accordance with a second communication protocol based on information from the first communication network, and to operate the second communication platform based on the condition indicative of the wireless connection,
wherein the information is associated with one of the wireless electronic device or the second communication network.

25. A system as defined in claim 24, wherein the processor is configured to request for the information associated with one of the wireless electronic device or the second communication network via the first communication platform.

26. A system as defined in claim 24, wherein the processor is configured to transmit a network request message via the first communication platform to a server associated with the second communication network.

27. A system as defined in claim 24, wherein the processor is configured to monitor for the information associated with one of the wireless electronic device or the second communication network via the first communication platform.

28. A system as defined in claim 24, wherein the processor is configured to receive a broadcast message having the information associated with one of the wireless electronic device or the second communication network via the first communication platform.

29. A system as defined in claim 24, wherein the processor is configured to identify the condition indicative of the wireless connection associated with the second communication platform and the second communication network based on information associated with movement characteristic of the wireless electronic device.

30. A system as defined in claim 24, wherein the processor is configured to operate the second communication platform in a sleep mode in response to one of a condition indicative of the wireless connection having a signal strength below a threshold or a condition indicative of a failure to connect the wireless electronic device and the second communication network.
